(19) United States
(12) Patent Application Publication
(10) Pub. No.: US 2025/0386248 A1
(43) Pub. Date: Dec. 18, 2025

(54) FLOW TABLE PROCESSING METHOD, APPARATUS, COMPUTER, STORAGE MEDIUM AND PROGRAM PRODUCT

(71) Applicant: Beijing Volcano Engine Technology Co., Ltd., Beijing (CN)

(72) Inventors: Pengcheng MA, Beijing (CN); Xiongchun DUAN, Beijing (CN); Zhongjun ZHANG, Singapore (SG); Zhiqiang YOU, Beijing (CN); Jiashuai ZHAO, Beijing (CN); Zihan PENG, Beijing (CN)

(21) Appl. No.: 19/088,915

(22) Filed: Mar. 24, 2025

(30) Foreign Application Priority Data
Jun. 17, 2024 (CN) 202410775347.7

(51) Int. Cl. H04W 28/10; H04L 12/46; H04L 45/74

(52) U.S. Cl. CPC H04W 28/10; H04L 12/4641; H04L 45/74

(57) ABSTRACT

The present disclosure relates to a flow table processing method. The method comprises: obtaining a type of an access point in a target branch network of a software defined wide area network, and determining a first access point and a second access point in the target branch network; obtaining preset address information assigned to the first access point; generating a flow table of the second access point based on the preset address information; and sending the flow table to the second access point, to cause the second access point to transmit data in the target branch network based on the flow table

### CROSS-REFERENCE TO RELATED APPLICATION(S)

This application claims priority to Chinese Application No. 202410775347.7 filed on Jun. 17, 2024, the disclosure of which is incorporated herein by reference in its entirety.

### FIELD

The present disclosure relates to the field of computer technologies, and in particular, to a flow table processing method and apparatus, a computer, a storage medium, and a program product.

### BACKGROUND

As a virtual wide area network architecture, a software defined wide area network (SD-WAN) includes multiple network nodes for forwarding and processing data, and allows enterprises or other organizations to combine the network nodes therein using any combination of transmission services to transmit data. With the deepening of enterprise digital transformation, the number of cloud-deployed office systems has increased substantially, and the demand for Saas (Software-as-a-Service) services has increased. At the same time, the connection between enterprise branches has become closer, showing characteristics such as increased bandwidth requirements, frequent internal service activation, and faster network architecture changes. Therefore, when providing wide area network services for SaaS, it is usually necessary to adopt SD-WAN deployment.

When data transmission is performed through SD-WAN, the Openflow protocol is usually used, and the concept of “flow table” is introduced in Openflow. The flow table is a set of rules for data forwarding. Through the pre-assigned flow table, the network nodes in the SD-WAN can efficiently process and forward data packets according to pre-defined rules. Specifically, a network node usually needs to distinguish a tenant corresponding to each data packet, routing information of a sending and receiving device, and the like, and perform matching in the flow table, so as to forward the data packet according to a matching result.

### SUMMARY

In view of this, the present disclosure provides a flow table processing method and apparatus, a computer, a storage medium, and a program product.

According to a first aspect, the present disclosure provides a flow table processing method. The method includes: obtaining a type of an access point in a target branch network of a software defined wide area network, and determining a first access point and a second access point in the target branch network, where the first access point is an access point configured to communicate data with a terminal device in the target branch network, and the second access point is an access point configured to communicate data with the first access point; obtaining preset address information assigned to the first access point; generating a flow table of the second access point based on the preset address information; and sending the flow table to the second access point, to cause the second access point to transmit data in the target branch network based on the flow table.

According to a second aspect, the present disclosure provides a flow table processing apparatus. The apparatus includes: a determining module, configured to obtain a type of an access point in a target branch network of a software defined wide area network, and determine a first access point and a second access point in the target branch network, where the first access point is an access point configured to communicate data with a terminal device in the target branch network, and the second access point is an access point configured to communicate data with the first access point; an obtaining module, configured to obtain preset address information assigned to the first access point; a generating module, configured to generate a flow table of the second access point based on the preset address information; and a sending module, configured to send the flow table to the second access point, to cause the second access point to transmit data in the target branch network based on the flow table.

According to a third aspect, the present disclosure provides a computer device. The computer device includes a memory and a processor, where the memory is in communication connection with the processor, the memory stores computer instructions, and the processor executes the computer instructions to perform the flow table processing method according to the first aspect or any one of the implementations thereof.

According to a fourth aspect, the present disclosure provides a computer-readable storage medium. The computer-readable storage medium stores computer instructions, and the computer instructions are configured to cause a computer to perform the flow table processing method according to the first aspect or any one of the implementations thereof.

According to a fifth aspect, the present disclosure provides a computer program product. The computer program product includes computer instructions, and the computer instructions are configured to cause a computer to perform the flow table processing method according to the first aspect or any one of the implementations thereof.

### BRIEF DESCRIPTION OF THE DRAWINGS

To illustrate the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art may still derive other drawings from these drawings without creative efforts.

FIG. 1 is a schematic diagram of a network architecture based on SD-WAN according to an embodiment of the present disclosure;

FIG. 2 is a flowchart of a flow table processing method according to an embodiment of the present disclosure;

FIG. 3 is a schematic diagram of an architecture of a target branch network;

FIG. 4 is a flowchart of another flow table processing method according to an embodiment of the present disclosure;

FIG. 5 is a block diagram of a structure of a flow table processing apparatus according to an embodiment of the present disclosure; and

FIG. 6 is a schematic diagram of a hardware structure of a computer device according to an embodiment of the present disclosure.

### DETAILED DESCRIPTION OF EMBODIMENTS

To make the objectives, technical solutions, and advantages of embodiments of the present disclosure clearer, the following clearly and comprehensively describes the technical solutions in the embodiments of the present disclosure with reference to the drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

In the description of the embodiments of the present disclosure, the term “include/comprise” and its similar terms should be interpreted as open and inclusive, that is, “include/comprise but not limited to”. The term “based on” should be interpreted as “based at least in part on”. The term “one embodiment” or “this embodiment” should be interpreted as “at least one embodiment”. The term “some embodiments” should be interpreted as “at least some embodiments”. Other explicit and implicit definitions may also be included below.

In this document, unless explicitly specified, performing a step “in response to A” does not mean that the step is performed immediately after “A”, but may include one or more intermediate steps.

It may be understood that the data involved in the technical solutions (including, but not limited to, the data itself, and the acquisition, use, storage, or deletion of the data) should comply with requirements of corresponding laws, regulations, and related provisions.

It may be understood that before using the technical solutions disclosed in the embodiments of the present disclosure, related users should be informed of the type, the use scope, the use scene, and the like of information involved in the present disclosure in an appropriate manner according to related laws and regulations, and authorization of the related users should be obtained, where the related users may include any type of right subjects, such as individuals, enterprises, and groups.

For example, in response to receiving an active request from a user, prompt information is sent to the related user, to explicitly prompt the related user that an operation requested to be performed by the related user will require acquisition and use of information about the related user, so that the related user can independently select, based on the prompt information, whether to provide information to software or hardware such as an electronic device, an application, a server, or a storage medium that performs the operation of the technical solution of the present disclosure.

As an optional but non-restrictive implementation, a manner of sending the prompt information to the related user in response to receiving the active request from the related user may be, for example, a pop-up window, where the prompt information may be presented in the pop-up window in a text form. In addition, the pop-up window may further carry a selection control for the user to select “agree” or “disagree” to provide the information to the electronic device.

With reference to an application scenario on which the execution of the flow table processing method depends, the application scenario is described here.

As a virtual wide area network architecture, a software defined wide area network (SD-WAN) includes multiple network nodes for forwarding and processing data, and allows enterprises or other organizations to combine the network nodes therein using any combination of transmission services to transmit data. With the deepening of enterprise digital transformation, the number of cloud-deployed office systems has increased substantially, and the demand for Saas (Software-as-a-Service) services has increased. At the same time, the connection between enterprise branches has become closer, showing characteristics such as increased bandwidth requirements, frequent internal service activation, and faster network architecture changes. Therefore, when providing wide area network services for SaaS, it is usually necessary to adopt SD-WAN deployment.

When data transmission is performed through SD-WAN, the Openflow protocol is usually used, and the concept of “flow table” is introduced in Openflow. The flow table is a set of rules for data forwarding. Through the pre-assigned flow table, the network nodes in the SD-WAN can efficiently process and forward data packets according to pre-defined rules. Specifically, a network node usually needs to distinguish a tenant corresponding to each data packet, routing information of a sending and receiving device, and the like, and perform matching in the flow table, so as to forward the data packet according to a matching result.

However, since the SD-WAN mentioned above needs to support various applications and SaaS services in an enterprise intranet, routing information of data packets is complex. Therefore, the number of flow tables that need to be processed in the SD-WAN is often very large, resulting in an increased load of a controller and a decreased data forwarding performance of the network node.

Specifically, the SD-WAN is generally divided into three parts: a management platform, a data plane, and a control plane. The management platform provides tenants with a unified platform for configuring, changing, and detecting a network status of the tenants. The data plane consists of a CPE (Customer Premises Equipment) and a PoP.

Here, the CPE is deployed in a user's branch network, headquarters, or cloud, and may be hardware or software vCPE, and is responsible for aggregating all proxy traffic in a local site. The POP is divided into an access PoP and a backbone PoP. The access PoP is physically close to a user CPE to ensure good “last mile” network quality, so as to meet requirements of enterprise users for remote office. The backbone POP has a small amount of data, and is responsible for processing traffic forwarding of all tenants, and therefore has high requirements on performance, such as throughput, forwarding, and processing delay.

In addition, the control plane consists of a controller, and provides a southbound interface and a northbound interface. The southbound interface provides the CPE with information such as a public network IP address, and the northbound interface provides a network configuration interface for the management platform. The controller is responsible for selecting an appropriate access POP for the CPE and constructing an overlay network that can correctly route data packets.

The controller and the POP adopt the Openflow protocol for routing data packets. The concept of “flow table” is introduced in Openflow, and the controller uses a flow table to direct the data plane to forward data packets. The flow table includes multiple flow entries. Each flow entry includes a match field, an instruction, and the like. Each time the data plane device receives a data packet, the data plane device parses a matched item from the data packet, and matches the matched item with a value of the match field in the flow entry. If the matching is successful, a corresponding instruction is performed. In each flow table, flow entries are sequentially performed. Therefore, the number of flow tables and flow entries has a great impact on the forwarding performance of the PoP. When a CPE aggregates network traffic of a branch of a tenant to a PoP, the access PoP needs to route a destination address of each data packet according to a flow table, and distinguish that the data packet is to be offloaded to a CPE of the branch of the tenant. The backbone PoP needs to distinguish traffic of all tenants, and perform flow table matching. The controller needs to deliver the flow table to the POP in advance, and update the flow table in real time according to a configuration of a user on the management platform, and deliver the flow table to the POP. Since the SD-WAN network needs to support various applications and SaaS services in an intranet of a multi-tenant customer, the controller needs to deliver a great number of flow tables, and the POP needs to process a great number of flow tables and flow entries. This will undoubtedly cause an increased load of the controller and a decreased forwarding performance of the PoP. Therefore, how to reduce the number of flow tables becomes a key problem.

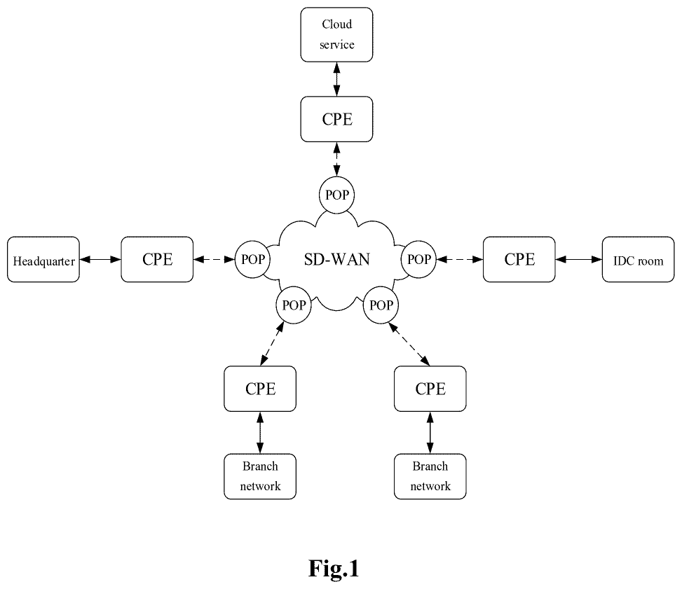

The network architecture based on a software defined wide area network (abbreviated as SD-WAN) adopted in the embodiments of the present disclosure mainly includes: a client for enterprise internal members, a customer premise equipment (abbreviated as CPE) of the SD-WAN, an access point (abbreviated as PoP), and a backbone POP (abbreviated as Core-PoP). Referring to FIG. 1, purposes of components in the network architecture of the present disclosure are as follows:
(1) The client is deployed on various terminal devices inside the enterprise, and members inside the enterprise can access application resources such as applications hosted in an Internet data center, a public cloud, and a private cloud, and SaaS applications through the client.
(2) The CPE is deployed at a headquarters, a branch network, an Internet data center (abbreviated as an IDC computer room), a cloud service (such as a public cloud or a private cloud), or the like of the enterprise. The CPE, as a branch gateway, is connected to clients in a local site/region, and is configured to aggregate all proxy traffic (for example, traffic of the clients) in the local site/region.
(3) The POP is connected to a physically close CPE, and the POP is configured to forward traffic aggregated by the CPE.
(4) The Core-POP needs to distinguish traffic of all tenants, and perform flow table matching.

According to an embodiment of the present disclosure, a video labeling method embodiment is provided. It should be noted that the steps shown in the flowcharts of the drawings may be executed in a computer system such as a set of computer-executable instructions, and although the steps are shown in the flowcharts in a logical order, the steps shown or described may be performed in a different order in some cases.

For example, in response to receiving an active request from a user, prompt information is sent to the user to explicitly prompt the user that an operation requested to be performed by the user will require acquisition and use of the user's personal information. This enables the user to independently select, based on the prompt information, whether to provide the personal information to software or hardware such as an electronic device, an application, a server, or a storage medium that performs the operation of the technical solution of the present disclosure.

As an optional but non-restrictive implementation, a manner of sending the prompt information to the user in response to receiving the active request from the user may be, for example, a pop-up window, where the prompt information may be presented in the pop-up window in a text form. In addition, the pop-up window may further carry a selection control for the user to select “agree” or “disagree” to provide the personal information to the electronic device.

It may be understood that the process of notifying and obtaining the user's authorization described above is merely illustrative, and does not constitute a limitation on implementations of the present disclosure. Other manners that satisfy related laws and regulations may also be applied to the implementations of the present disclosure.

Office security usually involves security management of a network, an identity, and a terminal. By implementing private network networking, access control, management of a terminal in a private network, and information security protection, digital office may be made safer, more efficient, and easier to use. Security management at the network layer may ensure that a private network such as an office network can operate safely and efficiently, thereby ensuring that service data can be transmitted and stored safely. Security management at the identity layer may improve the efficiency and security of identity authentication for a user to access a private network. Security management at the terminal layer may implement unified management of a terminal device in a private network, data leakage prevention, and terminal threat protection, thereby ensuring the security of enterprise data.

In practical applications, security management of a network, an identity, and a terminal may implement technical association in multiple technical branches such as networking policy, network admission and control, remote access, unified terminal management, terminal detection and response, enterprise data leakage prevention, and identity authentication management, so that digital office becomes easier, more efficient, and easier to implement.

According to an embodiment of the present disclosure, an embodiment of a flow table processing method is provided to solve the problem in the related art that an excessively large number of flow tables that need to be processed in the SD-WAN results in an increased load of a controller and a decreased data forwarding performance of a network node. It should be noted that the steps shown in the flowcharts of the drawings may be executed in a computer system such as a set of computer-executable instructions, and although the steps are shown in the flowcharts in a logical order, the steps shown or described may be performed in a different order in some cases.

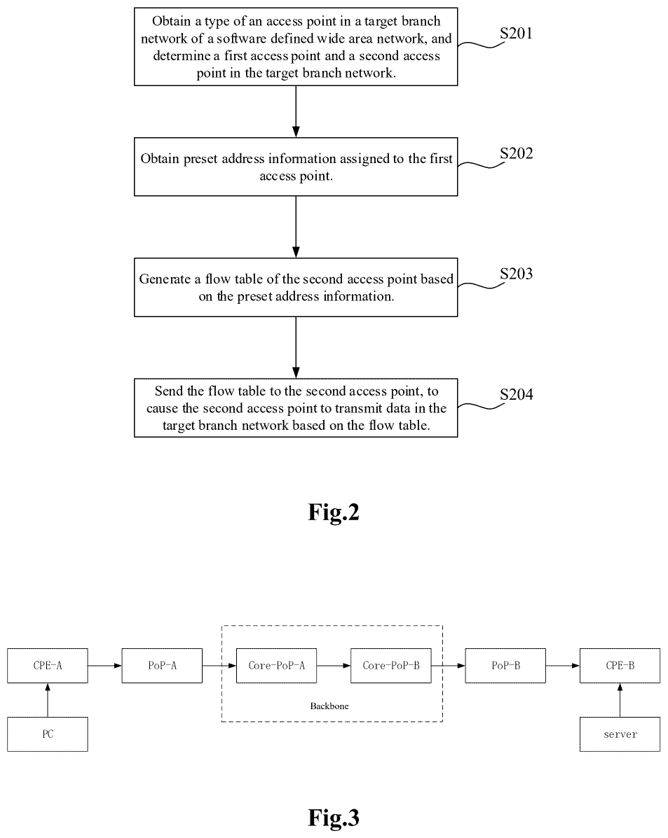

In this embodiment, a flow table processing method is provided, and the method may be applied to the above software defined wide area network (abbreviated as SD-WAN). FIG. 2 is a flowchart of a flow table processing method according to an embodiment of the present disclosure. As shown in FIG. 2, the process includes the following steps.
Step S201: Obtain a type of an access point in a target branch network of a software defined wide area network, and determine a first access point and a second access point in the target branch network, where the first access point is an access point configured to communicate data with a terminal device in the target branch network, and the second access point is an access point configured to communicate data with the first access point.

In the embodiment of the present disclosure, the SD-WAN may usually provide services such as network connection management, security policy making, and traffic control for multiple tenants, where the tenants may usually be enterprises. In the SD-WAN, each tenant may include multiple branch networks, and the branch network is usually configured to perform communication between a server and a client and communication between clients in the tenant. For example, the target branch network is configured to perform communication between a personal computer (PC) and an intranet server, where the PC is a terminal device of an employee in area 1 of an enterprise, and the server is a server deployed in area 2 of the enterprise.

FIG. 3 is a schematic diagram of an architecture of the target branch network. CPE-A and CPE-B are the first access point mentioned above, where CPE-A is configured to aggregate traffic of terminal devices of all employees in area 1 of the enterprise, and CPE-B is configured to aggregate all traffic of the server in area 2 of the enterprise.

In addition, the POP in FIG. 3 is the second access point mentioned above. The second access point includes: POP-A, PoP-B, Core-PoP-A, and Core-PoP-B. It should be understood that the POP in the SD-WAN is physically close to the CPE to ensure the network quality of the CPE. In addition, Core-PoP-A and Core-PoP-B are backbone PoPs in the backbone network. Here, the backbone network is responsible for processing traffic forwarding of all tenants, and therefore has high requirements on the performance of the backbone PoP, such as throughput, forwarding, and processing delay.

Therefore, at least one backbone POP may be allocated to each network branch in the SD-WAN. When allocating, the allocation may be performed according to a physical distance between the backbone PoP and the network branch. The specific allocation manner is not limited in the present disclosure.
Step S202: Obtain preset address information assigned to the first access point.
Step S203: Generate a flow table of the second access point based on the preset address information.

In the embodiment of the present disclosure, the preset address information may include a virtual address pre-assigned to the first access point. Here, the flow table may be generated based on a virtual address of a data receiving end device, for example, a virtual address (hereinafter referred to as a virtual IP) of CPE-B in FIG. 3.

It may be learned from the above that the flow table includes a match field, an instruction, and the like, where the match field is configured to match a matched item of a data packet, and if the matching is successful, a corresponding instruction is executed. Specifically, the matched item in the data packet generated in the present disclosure may include the virtual IP of the receiving end device. Therefore, when the flow table is generated for the second access point, the match field in the flow table may be generated based on the preset address information, and a corresponding instruction is configured for the match field, to obtain the flow table corresponding to the second access point.
Step S204: Send the flow table to the second access point, to cause the second access point to transmit data in the target branch network based on the flow table.

In the embodiment of the present disclosure, after the flow table is generated, the flow table may be delivered to the corresponding second access point by using the controller in the SD-WAN. Here, implementations of generating and configuring the flow table in the present disclosure are as follows.

It is assumed that the SD-WAN includes a tenant T, and the tenant T includes a user t1 and a server t2. A first access point where the user t1 is located is CPE-A, a first access point where the server t2 is located is CPE-B, and virtual IPs assigned to the CPE-A and the CPE-B are IP1 and IP2, respectively. The target network branch corresponding to the user t1 and the server t2 further includes second access points: PoP-A, PoP-B, Core-PoP-A, and Core-PoP-B. In addition, a network identifier of a virtual network assigned to the tenant T is VNI.

Then, when the user t1 wants to access the server t2 through the target network branch, a flow table delivered by the controller to the POP-A is as follows: match: Destination IP (IP2), InPort (0x11); instruction: Output (Core-PoP-A). Here, Destination is configured to indicate a destination IP2 of data transmission and a virtual network 0x11 to which the target branch network belongs, InPort is configured to indicate a processing instruction for a data packet that is preset, and Output is configured to indicate a transmission address of a next hop in a data packet transmission process.

A flow table delivered by the controller to the Core-PoP-A is as follows: match: Destination IP (IP2); instruction: Output (Core-PoP-B).

A flow table delivered by the controller to the Core-PoP-B is as follows: match: Destination IP (IP2); instruction: Output (PoP-B).

A flow table delivered by the controller to the PoP-B is as follows: match: instruction: Output (CPE-B).

It should be understood that the data transmission direction corresponding to the implementations of generating and configuring the flow table in the target branch network is from t1 to t2. If the target branch network supports two-way data transmission, the flow table may further be configured for the second access point according to the implementations of generating and configuring the flow table and an opposite data transmission direction. A specific configuration manner is not described in the present disclosure again.

It may be learned from the above description that in the embodiment of the present disclosure, a type of an access point in a target branch network of a software defined wide area network is first obtained, and a first access point and a second access point in the target branch network are determined, where the first access point is an access point configured to communicate data with a terminal device in the target branch network, and the second access point is an access point configured to communicate data with the first access point. Then, preset address information assigned to the first access point is obtained, and a flow table of the second access point is generated based on the preset address information. Next, the flow table is sent to the second access point, to cause the second access point to transmit data in the target branch network based on the flow table, thereby reducing a correlation between the flow table and real routing information of a device, generating the flow table by using the preset address information of the first access point in the branch network, to perform scheduling for a service access request (that is, traffic), and simplifying the number of flow tables that need to be configured.

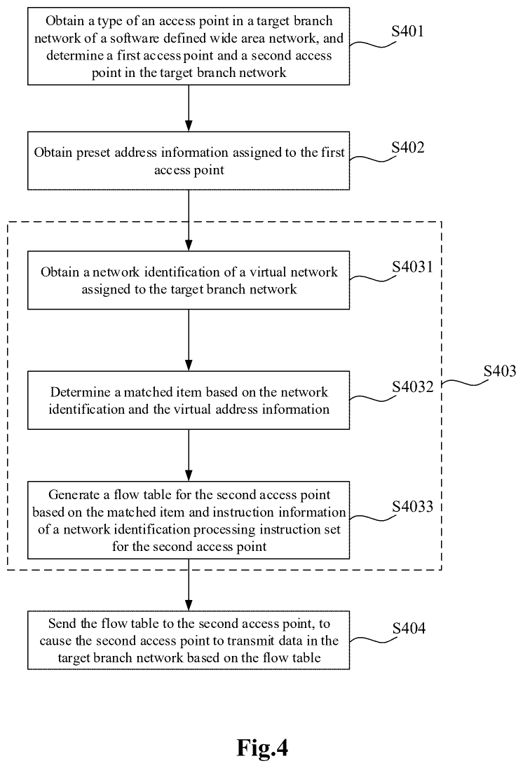

In this embodiment, another flow table processing method is provided, and the method may be applied to the above software defined wide area network (abbreviated as SD-WAN). FIG. 4 is a flowchart of another flow table processing method according to an embodiment of the present disclosure. As shown in FIG. 4, the process includes the following steps.
Step S401: Obtain a type of an access point in a target branch network of a software defined wide area network, and determine a first access point and a second access point in the target branch network, where the first access point is an access point configured to communicate data with a terminal device in the target branch network, and the second access point is an access point configured to communicate data with the first access point. For details, refer to step S201 in the embodiment shown in FIG. 2. Details are not described herein again.
Step S402: Obtain preset address information assigned to the first access point. For details, refer to step S202 in the embodiment shown in FIG. 2. Details are not described herein again.
Step S403: Generate a flow table of the second access point based on the preset address information.

Specifically, the preset address information includes: virtual address information of a fourth sub-access point in the first access point, where the fourth sub-access point includes an access point configured to communicate data with a receiving end in the terminal device. Step S403 includes the following steps.
Step S4031: Obtain a network identification of a virtual network assigned to the target branch network.
Step S4032: Determine a matched item based on the network identification and the virtual address information.
Step S4033: Generate a flow table for the second access point based on the matched item and instruction information of a network identification processing instruction set for the second access point.

In the embodiment of the present disclosure, corresponding virtual network areas may be assigned to different tenants in the SD-WAN, to meet service requirements of different tenants. For example, an enterprise may have different service requirements, such as some services requiring high bandwidth or low latency. By allocating different network resources, these requirements may be ensured to be met. In addition, a virtual IP, that is, the virtual address information, may be assigned to the first access point in the virtual network area, to generate the matched item based on the virtual IP.

Based on this, when the flow table is delivered to the access point in the target branch network, the virtual network of the tenant to which the target branch network belongs may be considered. Specifically, the matched item in the flow table may be determined based on a network identification of the virtual network, and the network identification may be represented as a VNI (VxLAN Network Identifier) in a form of VxLAN (0x11).

It should be understood that the network identification processing instruction in the flow table may be executed, to process the network identification in a data packet whose matching is successful. Specifically, the network identification processing instruction may include an encapsulation instruction and a decapsulation instruction for the network identification.

Next, the flow table of the second access point may be generated based on the matched item and the instruction information. Specifically, taking the target branch network corresponding to t1 and t2 as an example, a flow table generated for the second access point PoP-A is as follows: match: Destination IP (IP2), InPort (0x11); instruction: Push VxLan (0x11), Output (Core-PoP-A).
Step S404: Send the flow table to the second access point, to cause the second access point to transmit data in the target branch network based on the flow table. For details, refer to step S204 in the embodiment shown in FIG. 2. Details are not described herein again.

In the embodiment of the present disclosure, virtual IPs may be pre-assigned to CPEs in the SD-WAN, to generate a flow table for the POP in the target branch based on the virtual IP of the CPE corresponding to the receiving end device in the target branch, without generating the flow table based on a real IP of the receiving end device. In this way, the number of flow tables processed by the POP is irrelevant to the number of devices in the SD-WAN, but is only related to a topology diagram constructed based on the access point in the SD-WAN, thereby simplifying the number of flow tables that need to be configured. In some optional implementations, the network identification includes: a virtual extensible local area network (VXLAN) header. Step S4032 includes:
determining the matched item based on the network identification and the virtual address information, including:
encapsulating the VXLAN header, and determining the matched item based on an encapsulation result and the virtual address information.

In the embodiment of the present disclosure, the virtual extensible local area network (VXLAN) is an extension of the traditional VLAN protocol, and may be used for traffic isolation between different users in the SD-WAN network. Based on this, the VXLAN header may be encapsulated, to ensure the performance and security of a critical service application.

It should be understood that after data is transmitted to the fourth sub-access point, in response to a decapsulation instruction for the fourth sub-access point, the matched item corresponding to the flow table in the fourth sub-access point is obtained, and the VXLAN header in the matched item is decapsulated, to transmit the data to the CPE corresponding to the receiving end device through the fourth sub-access point.

In some optional implementations, the second access point includes: a first sub-access point and a second sub-access point, where the second sub-access point is configured to communicate data with the first access point, and communicate data with the first sub-access point. Step S4033 includes the following step.
Step a1: Generate a processing instruction for the network identification for the second sub-access point, and determine instruction information of the processing instruction, to generate a flow table for the second sub-access point according to the matched item and the instruction information.
Step a2: Generate a flow table for the first sub-access point based on a data transmission direction corresponding to the first sub-access point and the matched item.

In the embodiment of the present disclosure, a transmission address may be determined based on the data transmission direction corresponding to the second access point, to generate the flow table for the second access point based on the transmission address, the instruction information, and the matched item. Here, the transmission address may be configured to indicate an address of a next hop access point in a data transmission process. For example, when the current second access point is the above Core-PoP-A, and a corresponding next hop access point is Core-PoP-B, when the flow table of Core-PoP-A is determined, the flow table may be generated according to the instruction information, the matched item, and the transmission address of Core-PoP-B.

Specifically, step a2 includes the following steps.
(1) Determine the data transmission direction based on a data receiving end and a data sending end in the terminal device.
(2) Determine, based on the data transmission direction, a target access point that receives data and that corresponds to the first sub-access point, from access points in the target branch network.
(3) Generate a flow table for the backbone node based on an access point address of the target access point and the matched item.

In the embodiment of the present disclosure, it may be learned from the above that the second access point includes the POP and the backbone POP, where the first sub-access point is the backbone POP, and the second sub-access point is the POP. Specific functions of the POP and the backbone POP are as described in the embodiment corresponding to FIG. 2 above, and details are not described herein again. It should be understood that at least one backbone POP may be assigned to each branch network in the SD-WAN, for example, two backbone PoPs are assigned.

When the flow table is generated for the second sub-access point POP, considering that in the above target network branch, content of processing instructions corresponding to different PoPs is different, specifically, a corresponding processing instruction may be determined according to the CPE that exchanges data with the POP. Here, the instruction corresponding to the POP that exchanges data with the CPE corresponding to the receiving end device may be the decapsulation instruction, and the instruction corresponding to the POP that exchanges data with the CPE corresponding to the sending end device may be the encapsulation instruction.

For example, in FIG. 3, the processing instruction corresponding to the second sub-access point PoP-A is the encapsulation instruction. If the network identification is VxLan (0x11), the flow table generated for the PoP-A is as follows: match: Destination IP (IP2), InPort (0x11); instruction: Push VxLan (0x11), Output (Core-PoP-A). In addition, the processing instruction corresponding to the second sub-access point PoP-B is the encapsulation instruction. Then, the flow table generated for the PoP-B is as follows: match: VxLan (0x11); instruction: Output (CPE-B).

When the flow table is generated for the first sub-access point (the backbone POP), the data transmission direction may be determined based on the data receiving end and the data sending end in the device. Taking FIG. 3 as an example, the data sending end is the PC, and the receiving end is the server. Therefore, the data direction is from the PC to the server.

Then, the target access point corresponding to each backbone POP may be determined based on the data transmission direction, and the target access point is the next hop access point corresponding to the backbone POP in the target branch network. The transmission address of the next hop access point, that is, the access point address, is obtained. For example, in FIG. 3, the access point address of the next hop corresponding to Core-PoP-A is Core-PoP-B, and the access point address of the next hop corresponding to Core-PoP-B is PoP-B.

Based on this, a flow table generated for the first sub-access point Core-PoP-A is as follows: match: Destination IP (IP2); instruction: Output (Core-PoP-B). A flow table generated for the first sub-access point Core-PoP-B is as follows: match: Destination IP (IP2); instruction: Output (PoP-B).

In the embodiment of the present disclosure, the flow table may be generated for the second access point according to the virtual IP of the CPE and the access point address of the next hop corresponding to each second access point, so that the number of flow tables processed by the POP is irrelevant to the number of devices in the SD-WAN, but is only related to the topology diagram constructed based on the access point in the SD-WAN, thereby simplifying the number of flow tables that need to be configured.

In some optional implementations, the first access point includes: a third sub-access point and a fourth sub-access point, where the third sub-access point includes an access point configured to obtain data from a sending end in the device, and the fourth sub-access point includes an access point configured to communicate data with a receiving end in the device. The embodiment corresponding to FIG. 2 further includes the following steps.
Step s11: After sending the flow table to the second access point, obtain based on the third sub-access point a data packet sent by the sending end.
Step s12: Modify device address information in the data packet to the preset address information, and write the device address information into a preset position in the data packet, to obtain a target data packet, where the device address information is configured to indicate a ground truth address of the receiving end.
Step s13: Send the target data packet to the second access point.

In the embodiment of the present disclosure, the third sub-access point may be the CPE-A in FIG. 3. The device address information includes a real IP of the receiving end, that is, the device address information. It may be learned from the above that in the SD-WAN, the matched item in the flow table of the PoP includes the virtual IP of the CPE corresponding to the receiving end. Therefore, the real IP in the data packet may be replaced with the virtual IP.

Specifically, a real IP in option in the data packet header may be rewritten to a virtual IP by using network address translation (NAT), to obtain the target data packet. In addition, the real IP may be written into the preset position in the data packet header, so that the real IP can be read in a subsequent process.

In the embodiment of the present disclosure, the header of the received data packet may be rewritten, so that the real IP in the data packet is rewritten to the virtual IP of the first sub-access point in the target branch. In this way, the flow table is generated for the second sub-access point POP based on the virtual IP, so that the number of flow tables processed by the POP is irrelevant to the number of devices in the SD-WAN, but is only related to the topology diagram constructed based on the access point in the SD-WAN, thereby simplifying the number of flow tables that need to be configured.

In some optional implementations, the first access point includes: a fourth sub-access point, where the fourth sub-access point includes an access point configured to communicate data with the receiving end in the device. The embodiment corresponding to FIG. 2 further includes the following steps.
Step b1: After sending the target data packet to the second access point, obtain based on the fourth sub-access point the target data packet transmitted by the second access point.
Step b2: Read the device address information at the preset position, and replace the preset address information with the device address information, to send the target data packet to the receiving end according to the device address information.

In the embodiment of the present disclosure, the fourth sub-access point may be the CPE-B in FIG. 3. The CPE-B may be configured to replace the address of the target data packet, and send the target data packet to the receiving end device corresponding to the device address information (that is, the real IP) according to a replacement result, that is, the server in FIG. 3.

Specifically, the CPE-B may read the real IP at the preset position of the data packet, replace the virtual IP in the data packet header with the real IP, and send the target data packet to the server according to the real IP.

In the embodiment of the present disclosure, the virtual IP in the target data packet may be replaced with the real IP, to transmit the target data packet according to the real IP, thereby improving an overall implementation process of the present disclosure.

In some optional implementations, step S202 includes the following steps.
Step s21: Set a customized address for a first access point in each branch network in the software defined wide area network, to obtain an address list.
Step s22: Obtain the address list, and query the address list for the customized address corresponding to the first access point in the target branch network, to obtain the preset address information.

In the embodiment of the present disclosure, virtual IP definition for the access point may be implemented by using an IP Option (IP option, a network protocol function) technology. Specifically, the IP Option technology allows an IP data packet to carry additional control information, to provide a specific network service. For example, the control information may be the customized address.

Considering that the first access point is a gateway in the SD-WAN, a virtual IP may be set for the gateway, and the virtual IP is used instead of a real IP of the tenant when the flow table is generated, so that address reuse is implemented, and the number of flow tables is reduced.

In conclusion, in the embodiment of the present disclosure, a type of an access point in a target branch network of a software defined wide area network is first obtained, and a first access point and a second access point in the target branch network are determined, where the first access point is an access point configured to communicate data with a terminal device in the target branch network, and the second access point is an access point configured to communicate data with the first access point. Then, preset address information assigned to the first access point is obtained, and a flow table of the second access point is generated based on the preset address information. Next, the flow table is sent to the second access point, to cause the second access point to transmit data in the target branch network based on the flow table, thereby reducing a correlation between the flow table and real routing information of a device, generating the flow table by using the preset address information of the first access point in the branch network, to perform scheduling for a service access request (that is, traffic), and simplifying the number of flow tables that need to be configured.

In this embodiment, a flow table processing apparatus is further provided. The apparatus is configured to implement the above embodiments and preferred implementations, and details of the embodiments and preferred implementations are not described herein again. As used below, the term “module” may refer to a combination of software and/or hardware that can implement a predetermined function. Although the apparatus described in the following embodiment is preferably implemented by software, implementation by hardware, or a combination of software and hardware is also possible and contemplated.

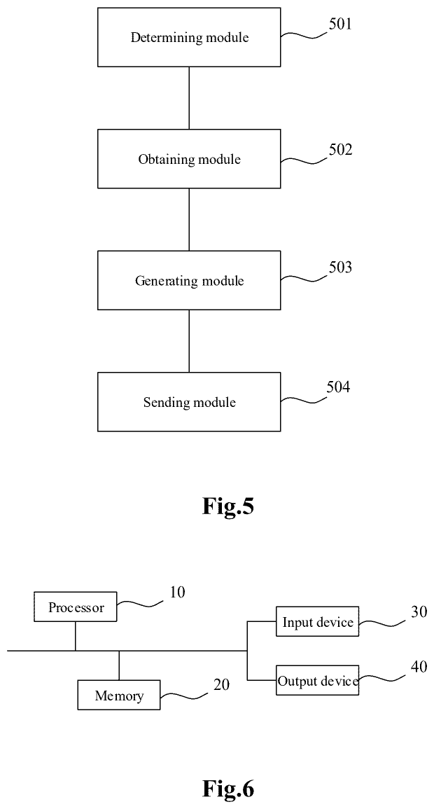

This embodiment provides a flow table processing apparatus. As shown in FIG. 5, the apparatus includes a determining module 501, an obtaining module 502, a generating module 503, and a sending module 504.

The determining module 501 is configured to obtain a type of an access point in a target branch network of a software defined wide area network, and determine a first access point and a second access point in the target branch network, where the first access point is an access point configured to communicate data with a terminal device in the target branch network, and the second access point is an access point configured to communicate data with the first access point.

The obtaining module 502 is configured to obtain preset address information assigned to the first access point.

The generating module 503 is configured to generate a flow table of the second access point based on the preset address information.

The sending module 504 is configured to send the flow table to the second access point, to cause the second access point to transmit data in the target branch network based on the flow table.

In some optional implementations, the preset address information includes: virtual address information of a fourth sub-access point in the first access point, where the fourth sub-access point includes an access point configured to communicate data with a receiving end in the terminal device. The generating module 503 includes:
a first obtaining unit, configured to obtain a network identification of a virtual network assigned to the target branch network;
a determining unit, configured to determine a matched item based on the network identification and the virtual address information; and
a generating unit, configured to generate a flow table for the second access point based on the matched item and instruction information of a network identification processing instruction set for the second access point.

In some optional implementations, the network identification includes: a virtual extensible local area network (VXLAN) header. The determining unit includes:
an encapsulation subunit, configured to encapsulate the VXLAN header, and determine the matched item based on an encapsulation result and the virtual address information.

In some optional implementations, the determining unit further includes:
a decapsulation subunit, configured to obtain, in response to a decapsulation instruction for the fourth sub-access point, the matched item corresponding to the flow table in the fourth sub-access point, and decapsulate the VXLAN header in the matched item.

In some optional implementations, the second access point includes: a first sub-access point and a second sub-access point, where the second sub-access point is configured to communicate data with the first access point, and communicate data with the first sub-access point. The generating unit includes:
a first determining subunit, configured to generate a processing instruction for the network identification for the second sub-access point, and determine instruction information of the processing instruction, to generate a flow table for the second sub-access point according to the matched item and the instruction information; and
a first generating subunit, configured to generate a flow table for the first sub-access point based on a data transmission direction corresponding to the first sub-access point and the matched item.

In some optional implementations, the step in which the flow table is generated for the second access point based on the matched item and the instruction information of the network identification processing instruction set for the second access point further includes the following steps.

A second determining subunit is configured to determine a transmission address based on the data transmission direction corresponding to the second access point.

A second generating subunit is configured to generate the flow table for the second access point based on the transmission address, the instruction information, and the matched item.

In some optional implementations, the generating subunit is further configured to:
determine the data transmission direction based on the data receiving end and the data sending end in the device;
determine, based on the data transmission direction, the target access point that receives data and that corresponds to the first sub-access point, from the access points in the target branch network; and
generate the flow table for the first sub-access point based on the access point address of the target access point and the matched item.

In some optional implementations, the first access point includes: a third sub-access point, where the third sub-access point includes an access point configured to obtain the data from the sending end in the terminal device. The apparatus further includes:
a second obtaining unit, configured to obtain, after sending the flow table to the second access point and based on the third sub-access point, the data packet sent by the sending end;
a writing unit, configured to modify the device address information in the data packet to the preset address information, and write the device address information into the preset position in the data packet, to obtain the target data packet, where the device address information is configured to indicate the ground truth address of the receiving end; and
a sending unit, configured to send the target data packet to the second access point.

In some optional implementations, the first access point includes: a fourth sub-access point, where the fourth sub-access point includes an access point configured to communicate data with the receiving end in the terminal device. The apparatus further includes:
a third obtaining unit, configured to obtain, after sending the target data packet to the second access point and based on the fourth sub-access point, the target data packet transmitted by the second access point; and
a replacing unit, configured to read the device address information at the preset position, and replace the preset address information with the device address information, to send the target data packet to the receiving end according to the device address information.

In some optional implementations, the obtaining module 502 includes:
a setting unit, configured to set the customized address for the first access point in each branch network in the software defined wide area network, to obtain the address list; and
a fourth obtaining unit, configured to obtain the address list, and query the address list for the customized address corresponding to the first access point in the target branch network, to obtain the preset address information.

For further functional descriptions of the foregoing modules and units, refer to the foregoing corresponding embodiments. Details are not described herein again.

The flow table processing apparatus in this embodiment is presented in the form of functional units. The units herein refer to an ASIC (Application Specific Integrated Circuit) circuit, a processor and a memory that execute one or more pieces of software or a fixed program, and/or other devices that can provide the foregoing functions.

According to an embodiment of the present disclosure, a computer device is further provided. The computer device has the flow table processing apparatus shown in FIG. 5.

According to the flow table processing method and apparatus, the computer, the storage medium, and the program product provided in the present disclosure, a type of an access point in a target branch network of a software defined wide area network is first obtained, and a first access point and a second access point in the target branch network are determined, where the first access point is an access point configured to communicate data with a terminal device in the target branch network, and the second access point is an access point configured to communicate data with the first access point. Then, preset address information assigned to the first access point is obtained, and a flow table of the second access point is generated based on the preset address information. Next, the flow table is sent to the second access point, to cause the second access point to transmit data in the target branch network based on the flow table, thereby reducing a correlation between the flow table and real routing information of a device, generating the flow table by using the preset address information of the first access point in the branch network, to perform scheduling for a service access request (that is, traffic), and simplifying the number of flow tables that need to be configured.

Referring to FIG. 6, FIG. 6 is a schematic diagram of a structure of a computer device according to an optional embodiment of the present disclosure. As shown in FIG. 6, the computer device includes: one or more processors 10, a memory 20, and interfaces for connecting various components, including a high-speed interface and a low-speed interface. The various components are in communication connection with each other by using different buses, and may be installed on a public main board or in other manners as required. The processor may process instructions executed in the computer device, including instructions stored in or on the memory to display graphical information of a GUI on an external input/output device (such as a display device coupled to the interface). In some optional implementations, if required, multiple processors and/or multiple buses may be used together with multiple memories and multiple memories. Similarly, multiple computer devices may be connected, and each device provides some necessary operations (for example, as a server array, a group of blade servers, or a multi-processor system). In FIG. 6, one processor 10 is used as an example.

The processor 10 may be a central processing unit, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable gate array, a generic array logic, or any combination thereof.

The memory 20 stores instructions executable by at least one processor 10, to cause the at least one processor 10 to implement the method shown in the above embodiments.

The memory 20 may include a program storage area and a data storage area, where the program storage area may store an operating system and an application required for at least one function, and the data storage area may store data created according to the use of the computer device. In addition, the memory 20 may include a high-speed random access memory, and may also include a non-transitory memory, such as at least one magnetic disk storage device, a flash memory device, or another non-transitory solid-state storage device. In some optional implementations, the memory 20 may optionally include a memory remotely provided relative to the processor 10, and these remote memories may be connected to the computer device through a network. Examples of the network include but are not limited to the Internet, an intranet, a local area network, a mobile communication network, and combinations thereof.

The memory 20 may include a volatile memory, such as a random access memory. The memory may also include a non-volatile memory, such as a flash memory, a hard disk, or a solid-state drive. The memory 20 may also include a combination of the foregoing types of memories.

The computer device further includes an input device 30 and an output device 40. The processor 10, the memory 20, the input device 30, and the output device 40 may be connected through a bus or in another manner. In FIG. 6, connection through a bus is used as an example.

The input device 30 may receive digital or character information input and generate key signal input related to user settings and function control of the computer device, such as a touchscreen, a keypad, a mouse, a trackpad, a touchpad, an indicating rod, one or more mouse buttons, a trackball, a joystick, and the like. The output device 40 may include a display device, an auxiliary lighting apparatus (for example, an LED), a tactile feedback apparatus (for example, a vibration motor), and the like. The display device includes but is not limited to a liquid crystal display, a light-emitting diode, a display, and a plasma display. In some optional implementations, the display device may be a touchscreen.

According to an embodiment of the present disclosure, a computer-readable storage medium is further provided. The method according to the embodiments of the present disclosure may be implemented in hardware or firmware, or may be implemented as computer code that may be recorded in a storage medium, or may be implemented as computer code that is originally stored in a remote storage medium or a non-transitory machine-readable storage medium and downloaded through a network and that is to be stored in a local storage medium. In this way, the method described herein may be stored in such software processing on a storage medium by using a general-purpose computer, a dedicated processor, or programmable or dedicated hardware. The storage medium may be a magnetic disk, an optical disc, a read-only memory, a random access memory, a flash memory, a hard disk, a solid-state drive, or the like. Further, the storage medium may further include a combination of the foregoing types of memories. It may be understood that the computer, the processor, the microprocessor controller, or the programmable hardware includes a storage component that may store or receive software or computer code. When the software or the computer code is accessed and executed by the computer, the processor, or the hardware, the method shown in the above embodiments is implemented.

It may be understood that before using the technical solutions disclosed in the embodiments of the present disclosure, users should be informed of the type, the use scope, the use scene, and the like of personal information involved in the present disclosure in an appropriate manner according to related laws and regulations, and authorization of the users should be obtained.

For example, in response to receiving an active request from a user, prompt information is sent to the user to explicitly prompt the user that an operation requested to be performed by the user will require acquisition and use of the user's personal information. This enables the user to independently select, based on the prompt information, whether to provide the personal information to software or hardware such as an electronic device, an application, a server, or a storage medium that performs the operation of the technical solution of the present disclosure.

As an optional but non-restrictive implementation, a manner of sending the prompt information to the user in response to receiving the active request from the user may be, for example, a pop-up window, where the prompt information may be presented in the pop-up window in a text form. In addition, the pop-up window may further carry a selection control for the user to select “agree” or “disagree” to provide the personal information to the electronic device.

It may be understood that the process of notifying and obtaining the user's authorization described above is merely illustrative, and does not constitute a limitation on implementations of the present disclosure. Other manners that satisfy related laws and regulations may also be applied to the implementations of the present disclosure.

A part of the present invention may be applied as a computer program product, for example, computer program instructions. When the computer program instructions are executed by a computer, the method and/or the technical solution according to the present invention may be called or provided through an operation of the computer. Those skilled in the art should understand that an existence form of the computer program instructions in a computer-readable medium includes but is not limited to a source file, an executable file, an installation package file, and the like. Correspondingly, a manner in which the computer program instructions are executed by the computer includes but is not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium that can be accessed by the computer.

Although the embodiments of the present disclosure are described with reference to the drawings, those skilled in the art may make various modifications and variations without departing from the spirit and scope of the present disclosure. These modifications and variations all fall within the scope defined by the appended claims.

I/We claim:

1. A flow table processing method applied to a software defined wide area network, the method comprising:
obtaining a type of an access point in a target branch network of the software defined wide area network, and determining a first access point and a second access point in the target branch network, wherein the first access point is an access point configured to communicate data with a terminal device in the target branch network, and the second access point is an access point configured to communicate data with the first access point;
obtaining preset address information assigned to the first access point;
generating a flow table of the second access point based on the preset address information; and
sending the flow table to the second access point to cause the second access point to transmit data in the target branch network based on the flow table.

2. The method according to claim 1, wherein the preset address information comprises: virtual address information of a fourth sub-access point in the first access point, wherein the fourth sub-access point comprises an access point configured to communicate data with a receiving end in the terminal device; and
wherein the generating the flow table of the second access point based on the preset address information comprises:
obtaining a network identification of a virtual network assigned to the target branch network;
determining a matched item based on the network identification and the virtual address information; and
generating the flow table for the second access point based on the matched item and instruction information of a network identification processing instruction set for the second access point.

3. The method according to claim 2, wherein the network identification comprises: a virtual extensible local area network VXLAN header; and
wherein the determining the matched item based on the network identification and the virtual address information comprises:
encapsulating the VXLAN header, and determining the matched item based on an encapsulation result and the virtual address information.

4. The method according to claim 3, wherein the method further comprises:
obtaining, in response to a decapsulation instruction for the fourth sub-access point, the matched item corresponding to the flow table in the fourth sub-access point, and decapsulating the VXLAN header in the matched item.

5. The method according to claim 2, wherein the second access point comprises: a first sub-access point and a second sub-access point, wherein the second sub-access point is configured to communicate data with the first access point, and communicate data with the first sub-access point; and
generating the flow table for the second access point based on the matched item and the instruction information of the network identification processing instruction set for the second access point comprises:
generating a processing instruction for the network identification for the second sub-access point, and determining instruction information of the processing instruction, to generate the flow table for the second sub-access point according to the matched item and the instruction information; and
generating a flow table for the first sub-access point based on a data transmission direction corresponding to the first sub-access point and the matched item.

6. The method according to claim 2, wherein generating the flow table for the second access point based on the matched item and the instruction information of the network identification processing instruction set for the second access point further comprises:
determining a transmission address based on a data transmission direction corresponding to the second access point; and
generating the flow table for the second access point based on the transmission address, the instruction information, and the matched item.

7. The method according to claim 5, wherein generating the flow table for the first sub-access point based on the data transmission direction corresponding to the first sub-access point and the matched item comprises:
determining the data transmission direction based on a data receiving end and a data sending end in the device;
determining, based on the data transmission direction, a target access point that corresponds to the first sub-access point and receives data from access points in the target branch network; and
generating the flow table for the first sub-access point based on an access point address of the target access point and the matched item.

8. The method according to claim 1, wherein the first access point comprises: a third sub-access point, wherein the third sub-access point comprises an access point configured to obtain data from a sending end in the terminal device; and
the method further comprises:
after sending the flow table to the second access point, obtaining based on the third sub-access point a data packet sent by the sending end;
modifying device address information in the data packet to the preset address information, and writing the device address information into a preset position in the data packet, to obtain a target data packet, wherein the device address information is configured to indicate a ground truth address of a receiving end in the terminal device; and
sending the target data packet to the second access point.

9. The method according to claim 8, wherein the first access point comprises: a fourth sub-access point, wherein the fourth sub-access point comprises an access point configured to communicate data with the receiving end in the terminal device; and
the method further comprises:
after sending the target data packet to the second access point, obtaining based on the fourth sub-access point the target data packet sent by the second access point; and
reading the device address information at the preset position, and replacing the preset address information with the device address information, to send the target data packet to the receiving end according to the device address information.

10. The method according to claim 1, wherein obtaining the preset address information assigned to the first access point comprises:
setting a customized address for a first access point in each branch network in the software defined wide area network, to obtain an address list; and
obtaining the address list, and querying the address list for the customized address corresponding to the first access point in the target branch network, to obtain the preset address information.

11. A device comprising:
a memory and a processor in communication connection with each other, wherein the memory stores computer instructions executable by the processor to perform a flow table processing method comprising:
obtaining a type of an access point in a target branch network of a software defined wide area network, and determining a first access point and a second access point in the target branch network, wherein the first access point is an access point configured to communicate data with a terminal device in the target branch network, and the second access point is an access point configured to communicate data with the first access point;
obtaining preset address information assigned to the first access point;
generating a flow table of the second access point based on the preset address information; and
sending the flow table to the second access point to cause the second access point to transmit data in the target branch network based on the flow table.

12. The device according to claim 11, wherein the preset address information comprises: virtual address information of a fourth sub-access point in the first access point, wherein the fourth sub-access point comprises an access point configured to communicate data with a receiving end in the terminal device; and
wherein the generating the flow table of the second access point based on the preset address information comprises:
obtaining a network identification of a virtual network assigned to the target branch network;
determining a matched item based on the network identification and the virtual address information; and
generating the flow table for the second access point based on the matched item and instruction information of a network identification processing instruction set for the second access point.

13. The device according to claim 12, wherein the network identification comprises: a virtual extensible local area network VXLAN header; and
wherein the determining the matched item based on the network identification and the virtual address information comprises:
encapsulating the VXLAN header, and determining the matched item based on an encapsulation result and the virtual address information.

14. The device according to claim 13, wherein the method further comprises:
obtaining, in response to a decapsulation instruction for the fourth sub-access point, the matched item corresponding to the flow table in the fourth sub-access point, and decapsulating the VXLAN header in the matched item.

15. The device according to claim 12, wherein the second access point comprises: a first sub-access point and a second sub-access point, wherein the second sub-access point is configured to communicate data with the first access point, and communicate data with the first sub-access point; and
the generating the flow table for the second access point based on the matched item and the instruction information of the network identification processing instruction set for the second access point comprises:
generating a processing instruction for the network identification for the second sub-access point, and determining instruction information of the processing instruction, to generate the flow table for the second sub-access point according to the matched item and the instruction information; and
generating a flow table for the first sub-access point based on a data transmission direction corresponding to the first sub-access point and the matched item.

16. The device according to claim 12, wherein generating the flow table for the second access point based on the matched item and the instruction information of the network identification processing instruction set for the second access point further comprises:
determining a transmission address based on a data transmission direction corresponding to the second access point; and
generating the flow table for the second access point based on the transmission address, the instruction information, and the matched item.

17. The device according to claim 15, wherein generating the flow table for the first sub-access point based on the data transmission direction corresponding to the first sub-access point and the matched item comprises:
determining the data transmission direction based on a data receiving end and a data sending end in the device;
determining, based on the data transmission direction, a target access point that corresponds to the first sub-access point and receives data from access points in the target branch network; and
generating the flow table for the first sub-access point based on an access point address of the target access point and the matched item.

18. The device according to claim 11, wherein the first access point comprises: a third sub-access point, wherein the third sub-access point comprises an access point configured to obtain data from a sending end in the terminal device; and
the method further comprises:
after sending the flow table to the second access point, obtaining based on the third sub-access point a data packet sent by the sending end;
modifying device address information in the data packet to the preset address information, and writing the device address information into a preset position in the data packet, to obtain a target data packet, wherein the device address information is configured to indicate a ground truth address of a receiving end in the terminal device; and
sending the target data packet to the second access point.

19. The device according to claim 18, wherein the first access point comprises: a fourth sub-access point, wherein the fourth sub-access point comprises an access point configured to communicate data with the receiving end in the terminal device; and
the method further comprises:
after sending the target data packet to the second access point, obtaining based on the fourth sub-access point the target data packet sent by the second access point; and
reading the device address information at the preset position, and replacing the preset address information with the device address information, to send the target data packet to the receiving end according to the device address information.

20. A non-transitory computer-readable storage medium storing computer instructions configured to cause a device to perform a flow table processing method comprising:
obtaining a type of an access point in a target branch network of a software defined wide area network, and determining a first access point and a second access point in the target branch network, wherein the first access point is an access point configured to communicate data with a terminal device in the target branch network, and the second access point is an access point configured to communicate data with the first access point;
obtaining preset address information assigned to the first access point;
generating a flow table of the second access point based on the preset address information; and
sending the flow table to the second access point to cause the second access point to transmit data in the target branch network based on the flow table.
